(19) United States
(12) Patent Application Publication
(10) Pub. No.: US 2023/0271545 A1
(43) Pub. Date: Aug. 31, 2023

(54) Systems and Methods for Various Systems of a Vehicle

(71) Applicant: Atlis Motor Vehicles, Inc., Mesa, AZ (US)

(72) Inventors: Mark Hanchett, Mesa, AZ (US); Benoit le Bourgeois, Mesa, AZ (US)

(73) Assignee: Atlis Motor Vehicles, Inc., Mesa, AZ (US)

(21) Appl. No.: 18/143,941

(22) Filed: May 5, 2023

Related U.S. Application Data
(60) Provisional application No. 63/340,153, filed on May 10, 2022.

(51) Int. Cl. B60Q 1/00; B60Q 1/04

(52) U.S. Cl. CPC B60Q 1/0023; B60Q 1/04; B60Q 2800/10

(57) ABSTRACT

Headlight and taillight assemblies may include cameras for providing video information. A barrier positioned between the cameras and the lamps of a headlight or taillight assembly reduces or eliminates light reflected from the lamps into the camera from an outer interface of the lens. The barriers enable the cameras to be positioned in close proximity to the lamps. Headlight and taillight assemblies may further include heaters to warm the lenses to melt ice or snow. Various methods may be used to install the headlight and taillight assemblies on the vehicle so the position of each headlight and taillight is known to a processing circuit.

### FIELD OF THE INVENTION

Embodiments of the present disclosure relate to vehicles and vehicle-like equipment.

### BACKGROUND

Vehicles and other vehicle-like equipment (e.g., tractors, agricultural equipment, construction equipment, excavation equipment) may be capable of being operated autonomously (e.g., self-driving, self-navigating), semi-autonomously, and/or with driver assistance. Vehicles and other vehicle-like equipment may benefit from headlight and taillight assemblies that include sensors that aid in autonomous operation. Headlight and taillight assemblies may further benefit from apparatus for removing snow and/or ice from the surface of the headlight and/or taillight assembly. Vehicles may further benefit from headlight and/or tail light assemblies that can identify where they are located on the vehicle.

### BRIEF DESCRIPTION OF THE DRAWING

Embodiments of the present invention will be described with reference to the drawing, wherein like designations denote like elements, and:

FIG. 1 is a perspective view of the front of a vehicle.

FIG. 2 is a view of the rear of a vehicle.

FIG. 3 is a perspective view of an example embodiment of a headlight assembly.

FIG. 4 is a cross-section of the headlight assembly of FIG. 3.

FIG. 5 is a close-up view of the headlight assembly of FIG. 4.

FIG. 6 is a top view of the lens and the barrier of FIG. 4.

FIG. 7 is a top view of the lens and the barrier of FIG. 4.

FIG. 8 is a perspective view of a mold for forming one of the lens and the barrier of FIGS. 3-7.

FIG. 9 front view of a lens with a resistive element.

FIG. 10 is a perspective view of an example embodiment of a taillight assembly.

FIG. 11 is a block diagram of a headlight/taillight system.

### DETAILED DESCRIPTION

### Introduction

Low-energy (e.g., LED) headlight and taillight assemblies produce less heat than conventional headlights and taillights, so snow and/or ice more readily accumulate on the exterior of the low-energy headlight and/or taillight assemblies. Low-energy headlights and taillights may include a heating element to heat the headlight and/or taillight assembly to keep them clear of snow and/or ice.

The components of a headlight assembly may be positioned in a housing relative to a horizontal axis to make the position of the components rotationally symmetrical with respect to a rotational axis. Rotationally symmetrical headlight assemblies may be positioned on either the front left side of the vehicle or the front right side of the vehicle without making changes to the headlight assembly. The components of a taillight assembly may also be positioned in the housing relative to horizontal axis so that components our rotationally symmetrical with respect to a rotational axis. Taillight assemblies that are rotationally symmetrical may be positioned at the left rear or the right rear of the vehicle we are making changes to the taillight assembly.

Self-driving vehicles generally include cameras, usually video cameras, to aid in collecting data regarding the surroundings of the vehicle. Such cameras may be incorporated into the headlight and/or taillight assemblies. The lens or cover of the headlight and/or taillight assembly may include coatings or structures that either redirect or absorb light so that light from the source in the headlight or the taillight assembly does not interfere with data collection by the camera.

Further, the headlight and taillight assemblies that include cameras may provide information to a vehicle controller as to the position (e.g., front, back, left, right) of the headlight and/or taillight assembly on the vehicle. Knowledge of the location of the headlight and/or taillight assembly helps the vehicle controller to properly construe the data coming from the cameras. In accordance with the present disclosure there are variety of ways that a headlight or taillight assembly may report their position.

Headlight and Taillight Assemblies

Vehicles and vehicle-like equipment are almost universally equipped with some type of lighting such as headlights and/or taillights. Headlights illuminate the road (e.g., path, work area) ahead (e.g., in front of) while taillights provide a warning light or illumination at the rear of the vehicle. A headlight (e.g., headlamp) assembly or a taillight assembly may also include a warning light on the side of the assembly. When the headlight assembly or the taillight assembly is installed on a vehicle, the side warning light is positioned on a side of the vehicle.

A headlight assembly typically emits white light to illuminate the area in front of the vehicle to improve driver visibility. However, a headlight assembly may also incorporate or function as a turn signal (e.g., flasher) and/or side warning lights which emit light of other colors. A headlight assembly may further include a fog light which may emit red or yellow light.

A taillight typically emits red light to alert drivers to the rear of the vehicle. A taillight may further include a backup light, which emits white light, and a side warning light, which typically emits amber (e.g., orange) colored light and a turn signal (e.g., light). A taillight may further function as a brake light by increasing the luminosity (e.g., brightness) of a taillight when the brakes are applied.

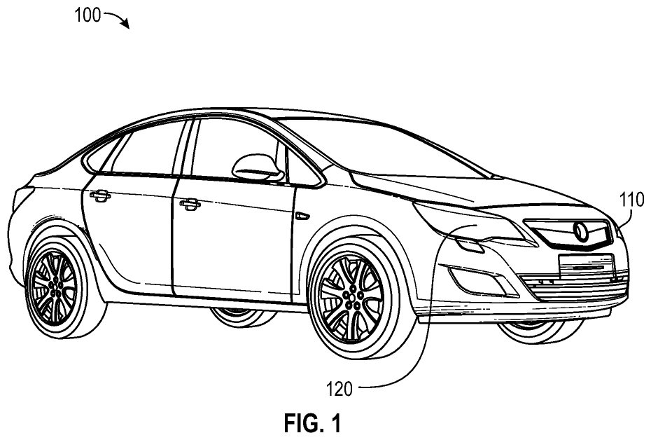

In an example embodiment, referring to FIG. 1, vehicle 100 has headlight assemblies 110 and 120. The headlight assembly 110 is positioned on the front left side (e.g., corner) of the vehicle 100 from the perspective of the driver while operating the vehicle. The left side and the right side of the vehicle are referred to as the driver-side and the passenger-side in the United States and other right-hand traffic countries. The headlight assembly 110 provides illumination in front of the vehicle 100 as well as a warning light or turn indicator on the front left side of the vehicle 100. Headlight assembly 120 is positioned on the front right side of the vehicle 100 and provides illumination in front of the vehicle 100 as well a warning light or turn indicator on the front right side of the vehicle 100.

As discussed below in greater detail, the headlight assembly 110 and the headlight assembly 120 are rotationally symmetrical (i.e., looks the same when rotated). So, during installation or replacement, the headlight assemblies 110 and 120 may be placed on either side (e.g., left, right) of the vehicle. In other words, the headlight assemblies 110 and the headlight assemblies 120 are interchangeable via being rotated. For example, headlight assembly 110 may be rotated 180° for use as headlight assembly 120. Headlight assemblies 110 and 120 may be identical. Either headlight assembly may be placed on either the left or right side of the vehicle 100 without further modification. The forward-facing portion of the headlight assembly may be lengthened so that when the headlight assembly 110 and 120 are placed on the vehicle, their front portions are positioned adjacent to each other thereby spanning most of or the entire width of the front of the vehicle.

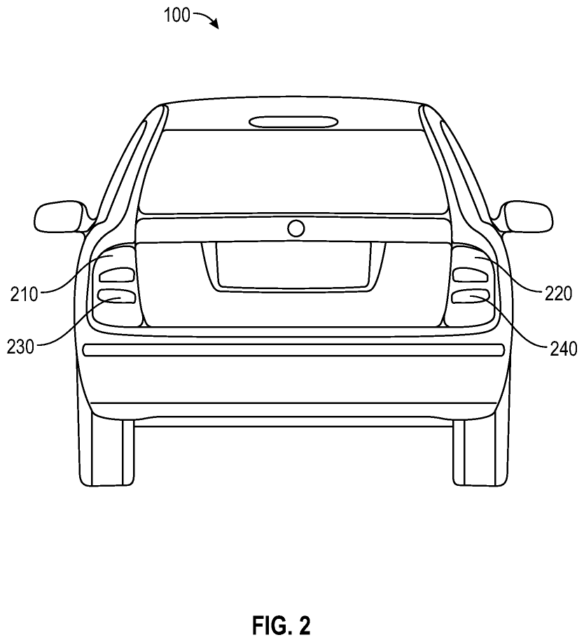

The rear of vehicle 100, best shown in FIG. 2, includes taillight assembly 210 on the rear left side (e.g., corner) of the vehicle 100 and taillight assembly 220 on the rear right side of the vehicle 100. As discussed above, the taillight assemblies 210 and 220 emit a red light that changes in intensity when braking. When vehicle 100 is operated in reverse, a white light is emitted through areas 230 and 240 of the taillight assemblies 210 and 220 respectively. The taillight assemblies 210 and 220 further include a warning light positioned on the left rear side and right rear side respectively of the vehicle 100.

The taillight assembly 210 and the taillight assembly 220 are also rotationally symmetrical so that the taillight assembly may be placed on either the rear left or the rear right of the vehicle. As with the headlight assembly, the rearward-facing portion of the taillight assembly may be lengthened so that when the taillight assemblies 210 and 220 are placed on the vehicle, their rear portions are positioned adjacent to each other thereby spanning most of or the entire width of the rear of the vehicle.

### Headlight Assembly Example Embodiment

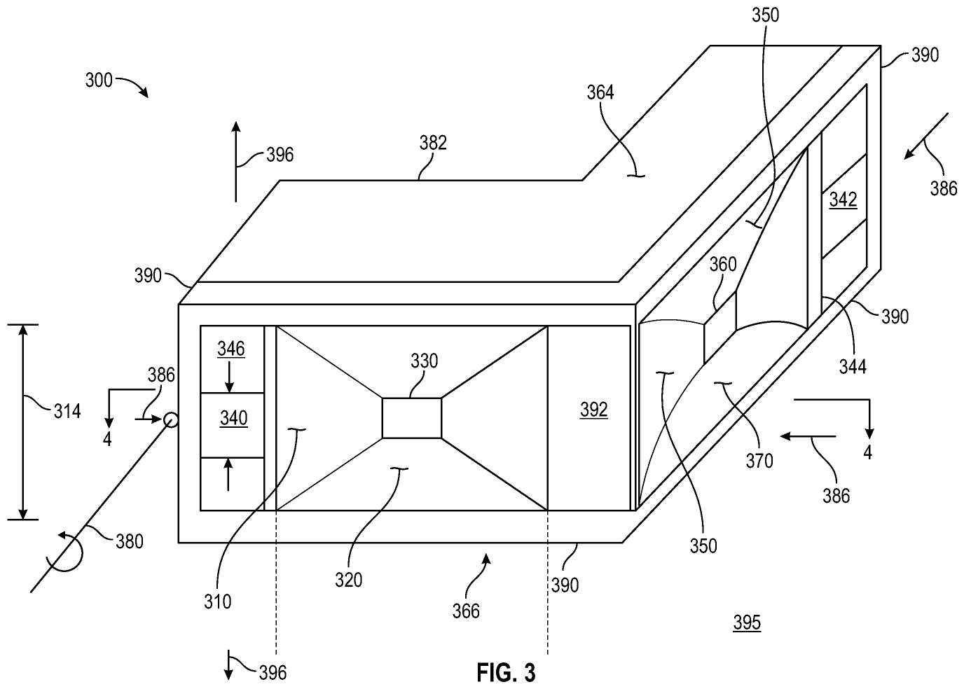

In an example embodiment, as best seen in FIG. 3, a headlight assembly 300 includes a source 330 (e.g., source of light), a source 360, a reflector 320, a reflector 370, a lens 310, a lens 350, a camera 340, a camera 342 and a housing 382.

The housing 382 includes a first side 364 (e.g., top in FIG. 3) and a second side 366 (e.g., bottom in FIG. 3). The housing 382 of the headlight assembly 300 encloses the source 330, the reflector 320, the lens 310, the source 360, the reflector 370, the lens 350, the camera 340 and the camera 342 between the first side 364 and the second side 366. The housing 382 positions the source 330, the reflector 320, the lens 310, the source 360, the reflector 370, the lens 350, the camera 340, the camera 342 and the mounting frame 390 with respect to each other.

In an example embodiment, the first portion of the housing 382 that holds the source 330, the reflector 320 and the camera 340 is oriented orthogonally to the second portion of the housing 382 that holds the source 360, the reflector 370 and the camera 342. Depending on the design of the vehicle 100, the orientation of first and second portions of the housing 382 may be more or less than 90°.

The source 330, the reflector 320, the lens 310, the source 360, the reflector 370, the lens 350, the camera 340 and the camera 342 each have a vertical midpoint axis. The vertical midpoint axis is the imaginary horizontal line across the middle of the component. In other words, half of the component is above the vertical midpoint axis and the other half is below the vertical midpoint axis. The housing 382 positions the vertical midpoint axes of the source 330, the reflector 320, the lens 310, the source 360, the reflector 370, the lens 350, the camera 340 and the camera 342 along a horizontal axis 386 of the headlight assembly 300. In other words, the camera 340, the source 330, the reflector 320, the source 360, the reflector 370 and the camera 340 are symmetrical about the horizontal axis 386, so that when the headlight assembly 300 is rotated 180° around the rotational axis 380, the components of headlight assembly 300 are positioned relative to each other into the ground in the same manner.

Because the headlight assembly 300 is rotationally symmetrical, a first headlight assembly 300 may be placed on the front left corner of the vehicle 100 as the headlight assembly 110 while a second headlight assembly 300 may be rotated and placed on the front right corner of the vehicle 100 as the headlight assembly 120 without any changes to the headlight assembly 300.

The sources 330 and 360 are positioned inside the reflectors 320 and 370 respectively. The sources 330 and 360 emit a plurality of beams (e.g., rays) of light respectively. The beams of light are emitted at a variety of directions (e.g., angles) with respect to the source. The sources 330 and 360 are positioned with respect to the reflectors 320 and 370 respectively so that the beams of light that would travel inward (e.g., backwards, side wards, not directly out) into the lamp are reflected and sent forward of the source. So, the beams of light that exit the headlight assembly 300 includes the light that comes directly from the sources 330 and 360 and the light that is redirected by the reflectors 320 and 370. The combination of a source and a reflector may be referred to as a light, a lamp, or a headlight or a taillight, depending on its position on vehicle 100.

The source 330 provides (e.g., emits) light that is visible to a human. While the headlight assembly 300 is positioned on vehicle 100, the light emitted from the source 330 is directed forward of the vehicle. Source 360 also provides light that is visible to a human. While the headlight assembly 300 is positioned on vehicle 100, the light emitted from the source 360 is directed to the side of the vehicle. In an example embodiment, the source 330 and the reflector 320 are oriented orthogonally with respect to the orientation of the source 360 and the reflector 370.

Examples of sources include incandescent bulbs, halogen bulbs, high intensity discharge (xenon) bulbs, and solid-state LEDs (e.g., light-emitting diodes). In an example embodiment, the source 330 and the source 360 include one or more LEDs. In an example embodiment, a plurality of LEDs are positioned relative to each other in rows and columns (e.g., an array). In another example embodiment, the source 360 and the source 330 are a single bulb respectively.

Reflectors 320 and 370 may have any shape suitable for directing beams of light out of the lamp. In an example embodiment, the shape of the reflectors 320 and 370 are substantially parabolic. Reflectors 320 and 370 may be formed of a single piece of material or of multiple pieces of material arranged together to approximate a parabolic shape. The reflectors 320 and 370 are formed of any material that reflects light. In an example embodiment, the reflectors 320 and 370 are formed of any material (e.g., metal, plastic) and coated with a reflective material (e.g., chrome plating). In example embodiment, the reflectors 320 and 370 are formed of material that operates as a heating element that is also coated to reflect light.

Lenses 310 and 350 protect the components of the headlight assembly 300 from the elements. The light from the sources 330 and 360 pass through the lenses 310 and 350 respectively. Each lens includes an inner surface (e.g., closer to the source) and an outer surface (e.g., further from the source) with respect to the source. The surfaces of the lens establish interfaces through which light travels from one medium to another.

For example, as a beam of light travels from a source to the inner surface of the lens, it travels through the gas that is trapped in the lamp (e.g., air). Because the transmission coefficient of the gas (e.g., 1) is different than the transmission coefficient of the lens (e.g., 1.3-1.9), the inner surface of the lens forms an inner interface (e.g., 450) where a beam of light may reflect or refract as it enters the material the lens. When a beam of light traveling through the material of the lens reaches the outer surface of the lens, the transmission coefficient again changes (e.g., lens to atmosphere), so the outer surface of the lens forms an outer interface (e.g., 452) where the beam of light may again reflect or refract as it exits the material the lens.

In an example embodiment, lens 310 includes the inner interface 450 between the air inside the headlight assembly 300 and the material of the lens 310. The lens 310 further includes the outer interface 452 between the material of the lens 310 and the atmosphere 394. At each interface, the light provided by the source 330 may reflect and/or refract. Materials may be used to decrease the number of beams of light that reflect from the inner surface of the lens. In an example embodiment, the inner surface of the lens 310 is coated with an anti-reflective coating. The anti-reflective coating reduces the amount of light that reflects from the inner interface 450 back into the headlight assembly 300.

The lenses 310 and 350 may be separate or formed together from the same material. The lenses 310 and 350 cover the sources 330 and 360 respectively. The lenses 310 and 350 protects the interior of the headlight assembly 300 from the outside elements. The lenses 310 and 350 may be sealed to the body of the headlight assembly 300 so that the interior of the headlight assembly 300 is hermetic. The lenses 310 and 350 may be sealed to a front portion of the reflector 320 and a front portion of the reflector 370 respectively. The lenses 310 and 350 may be sealed to a front portion of the camera 340 and the camera 342 respectively. The lenses 310 and 350 may be monolithic (e.g., formed of a single piece of material) or formed of multiple pieces of material.

Either or both of the outer surface and the inner surface may be curved. The inner surface the lenses 310 and/or 350 may curve in one direction (e.g., concave) while the outer surface of the lenses 310 and/or 350 may curve in another direction (e.g., convex). Either surface of the lenses 310 and 350 may have complex curves. The curves of the surfaces of the lenses 310 and 350 may diffuse or focus the light from the sources 330 and 360 respectively. However, in an example embodiment, the lenses 310 and 352 do not alter the direction of the transmission of the light as it passes through, except for refraction. Preferably, the lenses 310 and 350 are clear (e.g., optically transparent) to allow the transmission of light from the sources 330 and 360 without diminution.

In another example embodiment, the LEDs of the source 330 and/or the source 360 are directional LEDs in which the light from the LED travels, primarily, in a pre-determined direction (e.g., straight out). The LEDs of the source 330 and the source 360 are positioned relative to each other to provide light in a desired direction. In other words, the LEDs are positioned to direct the beams of light so that they exit the headlight assembly 300 in a desired direction.

### Heating Elements

In an example embodiment, as discussed above, the reflectors 320 and 370 also perform the function of heating the headlight assembly 300. The reflectors 320 and 370 are formed at least partially of electrical heating elements that are coated to reflect light. When the weather is cold (e.g., below a threshold temperature) or when ice buildup is detected on the headlight assembly 300 (e.g., on lens 310, on lens 350), the heating element portion of reflectors 320 and 370 are turned on to heat the headlight assembly 300 to melt the ice or snow on the lenses 310 and 350. In an example embodiment, reflector 320 comes into physical and thermal contact with lens 310 and/or the mounting frame 390. As the temperature of the reflector 320 increases, heat is transferred to the lens 310 and/or the mounting frame 390 to heat the lens 310 and/or the lens 350. The reflector 370 comes into physical and thermal contact with lens 350 and/or the mounting frame 390. As the temperature of the reflector 370 increases, heat is transferred to the lens 350 and/or the mounting frame 390. Thermal paste or some form of adhesive with high thermal transfer properties may be used to couple (e.g., connect) the reflector 320 to the lens 310 and/or the reflector 370 to the lens 350 or to the mounting frame 390. The mounting frame may independently be thermally connected to lens 310 and/or the lens 350.

In another example embodiment, only the portion of the reflectors 320 and 370 positioned proximate to the lenses 310 and 350 respectively and/or the mounting frame 390 function as a heating element. When the temperature is cold or there is ice or snow on the lenses 310 and 350, the heating element portion of the reflectors 320 and 370 are turned on to heat the lenses 310 and 350 and/or the mounting frame 390 to melt the ice or snow.

In another example embodiment, the mounting frame 390 is positioned around the edge of the headlight assembly 300. The mounting frame 390 is used to mount the headlight assembly 300 to the vehicle 100. In an example embodiment, the mounting frame 390 performs the function of heating the headlight assembly 300. The mounting frame 390 is in thermal contact with the lenses 310 and 350. The mounting frame 390 may include a gasket or other insulator that thermally separates the vehicle 100 from the headlight assembly 300 so that the mounting frame 390 heat only the headlight assembly 300, and in particular the lenses 310 and 350, as opposed to heating the material of the vehicle 100 around the headlight assembly 300.

In another example embodiment, headlight assembly 300 includes divider 392. Divider 392 divides the forward-directed (e.g., forward facing) portion of the headlight assembly 300 from the side-directed (e.g., side-ward facing) portion of the headlight assembly 300. The divider 392 may position (e.g., hold, support) the side of reflector 320 that is proximate to the side of reflector 370. The divider 392 may provide structural support to hold the lenses 310 and 350 in place. In an example embodiment, the divider performs the function of heating the headlight assembly 300. The divider may heat the lenses 310 and 350 and/or the reflectors 320 and 370 which in turn may heat the lenses 310 and 350.

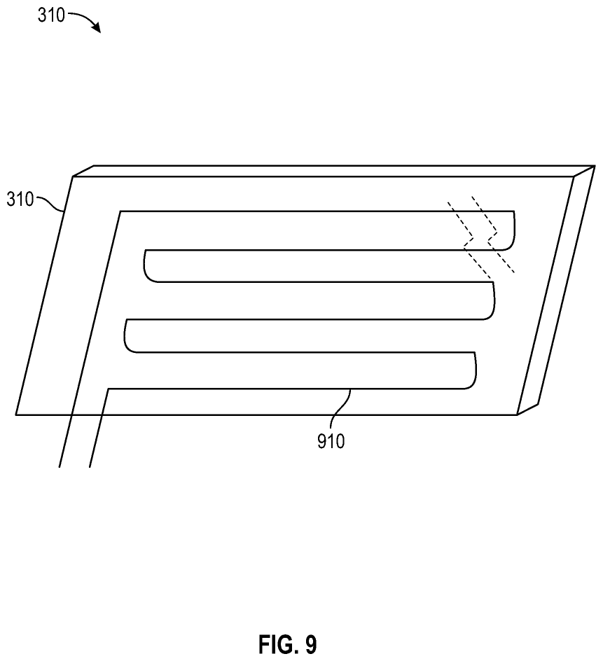

In another example embodiment, lens 310 includes a resistive element embedded in the material of the lens 310 as best shown in FIG. 9. Providing a current through the resistive element 910 causes the resistive element 910 to heat the lens 310.

The headlight assembly 300 may further include a thermostat (not shown). The thermostat detects the temperature of the headlight assembly 300, the lens 310, the lens 350, the reflector 320 and/or the reflector 370. The thermostat controls the heating element, in whatever form it may be (e.g., reflector 320, reflector 370, divider 392, mounting frame 390, resistive element 910) to maintain the headlight assembly 300 and/or the lenses 310 and 350 at or near a threshold temperature. Preferably, the threshold temperature is greater than freezing and high enough to melt ice or snow off the lenses 310 and 350.

The thermostat may include one or more sensors, not shown, positioned at any location on or in the headlight assembly 300 for detecting the temperature of the headlight assembly 300, the lens 310, the lens 350, the reflector 320 and/or the reflector 370. The thermostat further includes a power supply and processing circuit. The processing circuit receives the data (e.g., captured information) from the sensors to determine whether the power supply should be turned on to provide a current to the heating element to heat the headlight assembly 300.

The headlight assembly 300 may further include other sensors for detecting other physical characteristics of the headlight assembly 300 other than temperature. For example, the headlight assembly 300 may include one or more sensors for detecting whether the lenses 310 and/or 350 are obstructed. For example, ice, snow, mud and/or dirt may obstruct the lenses 310 and/or 350 thereby blocking the light from the sources 330 and/or 360. Information from the sensors may inform the processing circuit whether to heat the headlight assembly 300 or to activate some type of lens wiper (e.g., cleaner), not shown.

The power supply that provides the energy to the heating element of the headlight assembly 300 may be dedicated to the headlight assemblies and/or taillight assemblies or may provide power to other components of the vehicle 100. The headlight assembly 300 may include a connector for receiving energy from the power supply. The thermostat controls whether the energy from the power supply flows from the connector to the heating elements.

### Cameras and Rotational Symmetry

The headlight assembly 300 may further include one or more cameras (e.g., video cameras). As best shown in FIG. 3, camera 340 is positioned to the left of the reflector 320 whereas camera 342 is positioned to the right of the reflector 370. The camera 340 is separated from the reflector 320 by the barrier 384. The camera 342 is separated from the reflector 370 by the barrier 344. The barriers 384 and 344 optically separate the cameras 340 and 342 from the beams of light generated by the sources 330 and 360 respectively.

As discussed above, in an example embodiment, the headlight assembly 300 may be rotationally symmetrical so that the headlight assembly 300 may be positioned on the right side of the vehicle 100 or the left side of the vehicle 100 without change. For example, the headlight assembly 300 shown in FIG. 3 is oriented to be connected to the vehicle 100 as the front left headlight assembly 110. Rotating the headlight assembly 300 around the rotational axis 380 in the counterclockwise direction by 180° orients the headlight assembly 300 to be connected to the vehicle 100 as the front right headlight assembly 120.

The midpoints of the camera 340 and the source 330 are positioned along the horizontal axis 386. When the headlight assembly 300 is rotated 180° counterclockwise, the midpoint of the camera 340 and the midpoint the source 330 are still positioned along the horizontal axis 386. The same applies to the camera 342 and source 360. After rotation around the rotational axis 380, the midpoints of the camera 342 and the source 360 are positioned at the horizontal axis 386. As a result, the headlight assembly 300 is rotationally symmetrical and can be used on either side of the front of the vehicle 100 without manufacturing change.

In FIG. 3, the cameras 340 and 342 are defined as being oriented upright. So, after the headlight assembly 300 is rotated 180° counterclockwise around the rotational axis 380, the cameras 340 and 342 would no longer be oriented upright but would be oriented upside down. Which means that the visual data captured (e.g., captured images) by the cameras would be upside down. So, even though the cameras 340 and 342 are physically rotationally symmetrical, the data captured by the cameras 340 and 342 is not rotationally symmetrical. However, the processing circuit that receives the data from the cameras 340 and 342 may invert the data coming from the cameras so that the data is represented as being upright. In another embodiment, the cameras 340 and 342 may be programmed to invert the data, so the data is represented as being upright. As discussed in further detail below, the processing circuit may determine the position of a headlight assembly 300 with respect to the vehicle 100. The processing circuit may determine whether the headlight assembly or taillight assembly is on the front or the rear, the right or the left of the vehicle 100 and may determine whether the video from a camera should be inverted.

In another example embodiment, the camera 340 is positioned where the divider 392 is positioned in FIG. 3. Positioning the camera 340 at the position of the divider 392 may retain the midpoint of the camera 340 along the horizontal axis 386, so the headlight assembly 300 may operate as the left headlight assembly 110 or the right headlight assembly 120 without change. Similarly, the camera 342 may be positioned at any position along the horizontal axis 386 whether to the left or the right of the reflector 370.

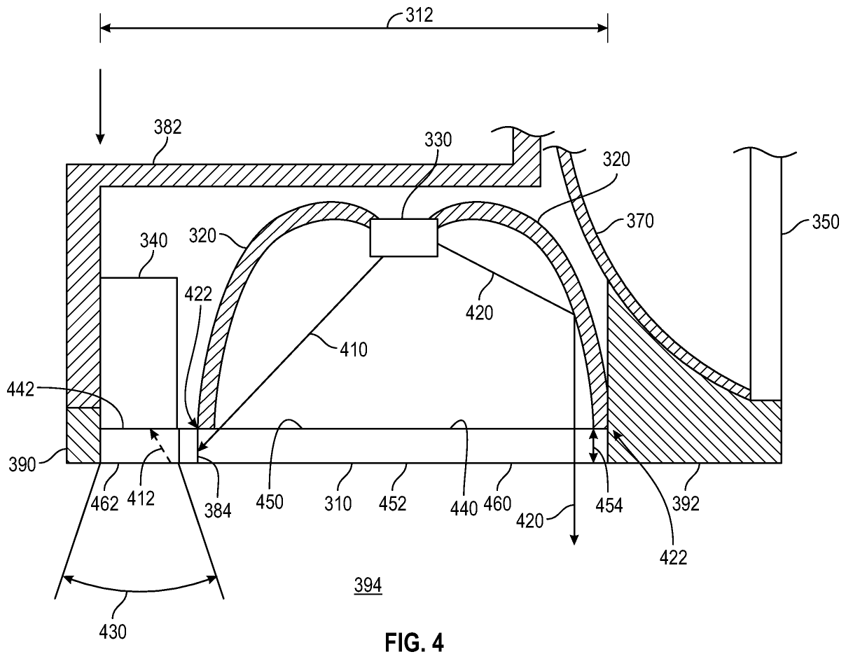

As best seen in FIG. 4, the camera 340 captures data within a field-of-view 430. The field-of-view 430 includes a horizontal components (e.g., width of area captured) and a vertical component (e.g., height of area captured). In an example embodiment, the horizontal field-of-view 430 is symmetrical about a vertical axis 396 that bisects the camera 340. Further, the horizontal field-of-view is symmetrical about the horizontal axis 386. A camera with a symmetrical field-of-view about the horizontal axes provides rotational symmetry with respect to the area in which the camera captures data. The camera need not have a symmetrical field-of-view about the vertical axis to provide symmetrical data capture when on either the left side (e.g., headlight assembly 110) or the right side (e.g., headlight assembly 120) of the vehicle. A horizontal symmetrical field-of-view provides symmetrical areas of capture on the left and the right side of the vehicle 100. Preferably, both the horizontal and vertical field-of-view of the camera are symmetrical about their respective axes.

### Barrier

In the example embodiments of FIGS. 3 and 4, a side (e.g., right side in FIGS. 3 and 4) of the camera 340 is positioned proximate to a side (e.g., left side in FIGS. 3 and 4) of the reflector 320. A front portion of the camera 340 is also positioned proximate to or touching the lens 310. The camera 340 captures data (e.g., video) through an aperture (e.g., opening) in the front of the camera 340. A front portion of the reflector 320 is also proximate to or in contact with the lens 310. Because the camera 340 is in close proximity with (e.g., opposite two) the reflector 320 and/or the source 330, beams of light from the source 330 may reflect from the outer interface 452 into the aperture at the front portion of the camera. The light that enters the aperture from the field-of-view 430 provides information regarding the objects in front of the vehicle 100. Reflected beams of light from the source 330 does not come from the field-of-view, so it contained no useful data regarding what lies in front of the vehicle 100. Reflected beams of light interfere with data capture in the field-of-view 430.

A side (e.g., left side in FIGS. 3 and 4) of the camera 342 is positioned proximate to (e.g., opposite) a side (e.g., right side in FIGS. 3 and 4) of the reflector 370. The front portion of the camera 342 is also positioned proximate to or touching the lens 350. The camera 342 also captures data through an aperture in the front of the camera 342. A front portion of the reflector 370 is also proximate to or in contact with the lens 350. Because the camera 342 is in close proximity with the reflector 370 and/or the source 360, beams of light from the source 360 may reflect from the outer interface of the lens 350 into the aperture of the camera to interfere with data captured by the camera.

Although the position of camera 342 with respect to the source 330, the lens 350 and the barrier 344 are not shown in FIG. 4, the function of the barrier 384 as discussed herein with respect to the camera 340, the source 330 and the lens 310 equally and similarly applies to the barrier 344, the camera 342, the source 360 and the lens 350 even though not specifically discussed herein.

Preferably, the camera 340 is positioned as close to reflector 320 as possible to reduce the overall size of the headlight assembly 300. Further, the camera 340 is positioned close to or touching the inner surface of the lens 310 so that the field-of-view of the camera 340 is not obstructed. However, proximity of the camera to the reflector 320 and the lens 310 may result in light reflecting from the lens 310 into the camera 340 thereby interfering with data collection by the camera 340. The barrier 384 reduces, if not eliminates, reflected light from the source 330 into the camera 340.

For example, referring to FIG. 4, beam of light 410 exits the source 330 in a direction toward the camera 340. Assumed that the beam of light 410 passes through the inner interface 450 without reflection. As the beam of light 410 travels through the material of the lens 310, it strikes (e.g., reaches, impinges upon) the barrier 384. The barrier 384 stops the beam of light 410 from reaching the outer interface 452. Stopping the beam of light 410 from reaching the outer interface 452 means that the beam of light 410 cannot reflect from the outer interface 452 into the camera. In other words, the barrier 384 stops the interference of light from source 330 with the data capture performed by the camera 340 thereby reducing interference with the image capture of the camera 340.

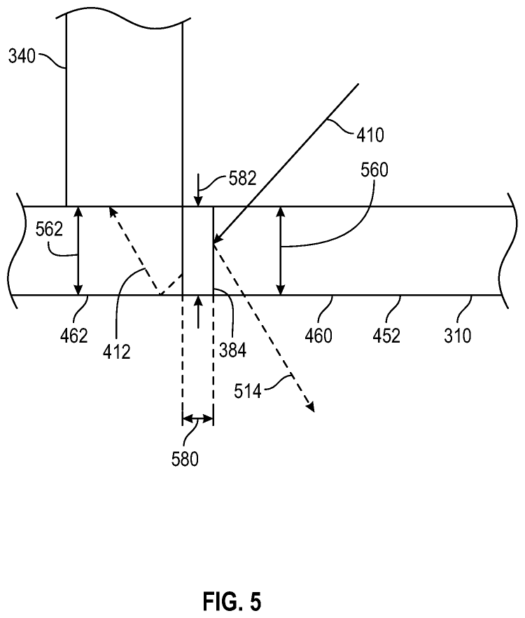

As best seen in FIG. 5, the beam of light 410 travels from source 330 through the material of the lens 310 to the barrier 384. If the barrier 384 did not exist, the beam of light 410 could reflect at the outer interface 452, as reflected beam 412, into the aperture of the camera.

Beams of light from the source 330 that reflect (e.g., reflected beam 412) into the camera 340 have no information regarding what is in front of the vehicle 100. Preferably, the camera 340 captures data regarding objects in front of the vehicle 100 that are illuminated by the source 330 (e.g., beam 420). So, the barrier 384 stops reflected beams of light from the source 330 from interfering with, or degrading, the data capture performed by the camera 340. The barrier 384 enables the camera 340 to be able to be placed in close proximity with the source 330 (e.g., the reflector 320) and close to the lens 310. Without the barrier 384, the camera 340 would either need to be placed further away (e.g., leftward in FIGS. 3 and 4) from the reflector 320 of the source 330 thereby increasing the size of the headlight assembly 300 or away (e.g., further) from the lens 310 thereby possibly decreasing the field-of-view of the camera 340.

In an example embodiment, as shown in FIGS. 3 and 4, the camera 340 is positioned on a first side of the barrier 384 and the reflector 320 is positioned on a second side of the barrier 384 opposite the camera 340. In this example embodiment, the side of the camera 340 is separated from the side of the reflector 320 by the width 580 of the barrier. Preferably, the camera is placed very close to the first side of the barrier and the reflector 320 is placed very close to the second side of the barrier, thereby reducing the distance between the camera 340 and the reflector 320 and thereby the size of the headlight assembly 300. Preferably, the barrier 348 does not overlap with (e.g., cover) the camera 340 or the reflector 320.

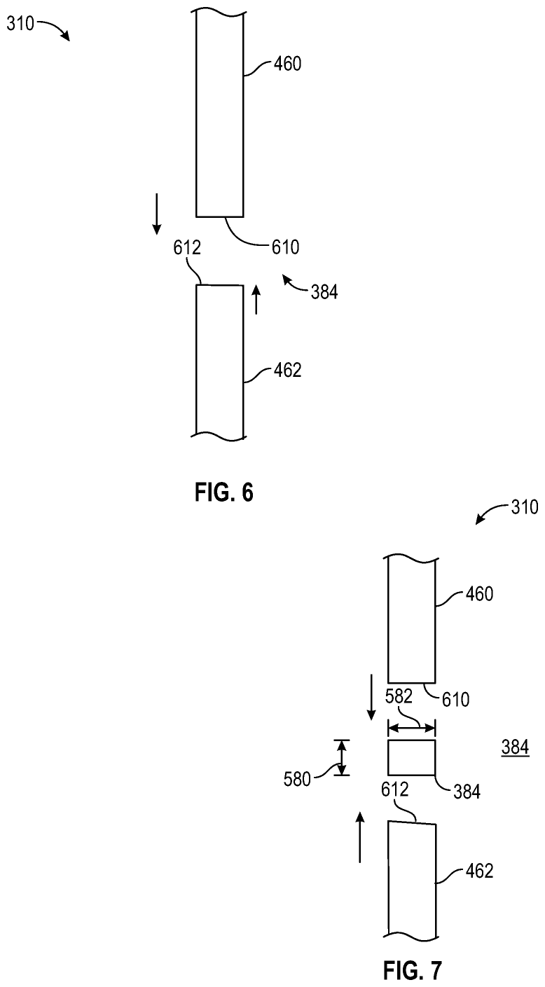

In an example embodiment, as best shown in FIG. 6, the lens 310 is formed of portion (e.g., section, segment) 460 and portion 462. The end portion 610 of the portion 460 and/or the end portion 612 of the portion 462 are highly polished and thereby optically reflective. When the portions 460 and 462 are positioned next to each other, the highly polished surfaces of end portion 610 and/or end portion 612 form the barrier 384. When the beam of light 410 strikes the highly polished surface of end portion 610 and/or end portion 612, it reflects as light ray 514 thereby precluding reaching and reflecting from the outer interface 452 and thereby interfering with data capture by the camera 340. In this example embodiment, the thickness 582 of the barrier 384 is the thickness 354 of the lens 310. The width 580 of the barrier 384 is very small, only the thickness of a polished layer on the end portion 610 and/or the end portion 612. The height of the barrier 384 is equal to (e.g., the same as) the height 314 of the lens 310 if the end portions 610 and/or 612 were polished along the entire height 314 of the lens 310. In another example embodiment, the height of the barrier is about (e.g., ±10%-50%) the height 346 of the camera 340. If the height of the barrier is less than the height 314 of the lens 310, the midpoint of the barrier 384 is placed along the horizontal axis 386 so that the entire height 346 of the camera 340 is adjacent to the barrier 384.

In another example embodiment, best shown in FIG. 7, the barrier 384 is a piece of material positioned in between the end portion 610 of the portion 460 and the end portion 612 of the portion 462. The portions 460 and 462 are brought together to hold the barrier 384 in place. The portions 460 and 462 may hold barrier 384 in place by pressure (e.g., pressed together) or an adhesive may be used. The adhesive may seal between the end portions 610 and 612 of the portions 460 and 462 to keep debris and contaminants out of the headlight assembly 300. Materials for the barrier 384 may any suitable material for either reflecting or absorbing (e.g., stopping, blocking) the beam of light 410. Suitable materials include a thin-film (e.g., plastic, metal, polymer), a metal, and a polymer. In this example embodiment, thickness 582 of the barrier 384 is about (e.g., ±1%-5%) the same as the thickness 454 of the lens 310. The width 580 of the barrier 384 depends on the type of material used and how it is attached to the end portions 610 and 612. In an example embodiment, the barrier 384 is formed of a material whose thickness result in a width 580 of between 0.05 mm and 0.5 mm. In this embodiment, the height of the barrier 384 is the height 314 of the lens 310 so that the barrier 384 is positioned along the entire height of the end portions 610 and 612 leaving no gap above or below the barrier 384.

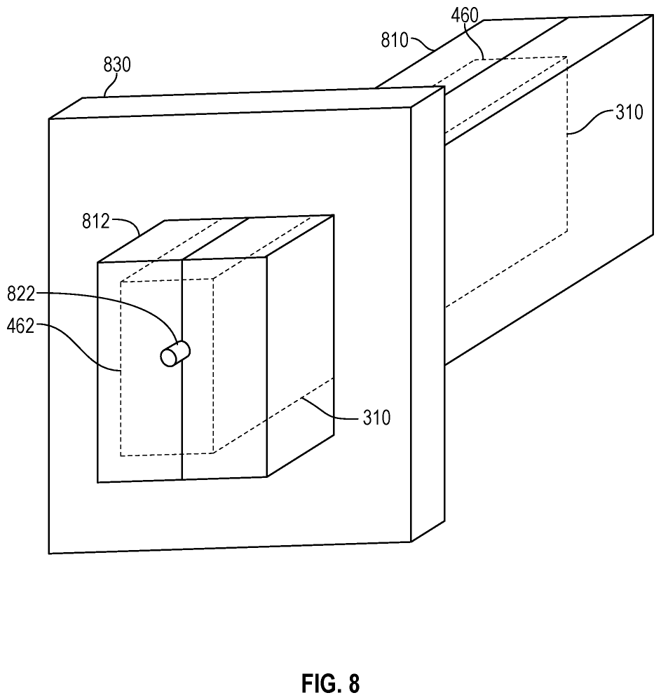

In another example embodiment, the barrier 384 is positioned between the portions 460 and 462 at the same time that the portions 460 and 462 are formed. Referring to FIG. 8, a mold 810 is used to form the portion 460 of the lens 310. The mold 812 is used to form the portion 462 of the lens 310. Prior to injecting material into the molds 810 and 812, the barrier material 830 is placed between the molds. The molds 810 and 812 are held in position against the barrier material 830 while the material that forms the lens 310 is injected into the mold. The lens material is injected into the mold 812 via the inlet 122. The mold 810 has a similar inlet that that is not shown. During injection, the lens material comes into contact with the barrier material 830. The lens material couples to (e.g., fuses to, attaches to, bonds with) the barrier material 830.

When the molds 810 and 812 are removed, the portion 460, the barrier material 830, and the portion 462 form an integral piece. In the example embodiment of FIG. 8, the barrier material extends beyond the lens 310 and must be trimmed. In another example embodiment, the barrier material 830 is inserted into the mold in such a manner that trimming is not necessary.

In another example embodiment, the lens 310 is formed of a single piece of material. The barrier 384 is formed using subsurface laser engraving. Subsurface laser engraving focuses a laser beam at a location inside the material of the lens 310 in the area where the barrier 384 is to be formed. The laser disrupts (e.g., melts, discolors, burns) the material of the lens 310 at the location where the laser is focused. Generally, the laser beam disrupts only a small amount of the material of the lens 310 at a time, so the laser must be fired (e.g., activated) multiple times at different focal points to form the barrier 384. For example, in glass, subsurface laser engraving causes either a small crack or a bubble, on the order of up to 2 mm, in the glass at the point where the laser beam is focused. The laser beam must be energized at numerous different focal point to form the barrier 384. A barrier formed using subsurface laser engraving either absorbs the beam of light 410 or scatters it multiple times so that little or no light (e.g., reflected beam 412) reflects into the camera 340.

Subsurface laser engraving may be used to form a barrier whose height is at least as great as the height 346 of the camera 340 and positioned along the height 346 of the camera 340. In other words, the height of this shorter barrier 384 is at least as great as the height 346 of the camera 340, but less than the height 314 of the lens. The camera 340 is positioned on one side of this shorter barrier 384 while the reflector 320 is placed on the other side of the shorter barrier 384. The area above and below the shorter barrier 384 is not disrupted and is optically clear. Since the shorter barrier 384 is positioned along the height 346 of the camera 340, it is rotationally symmetrical about the horizontal axis 386.

In example embodiments discussed above regarding the lens 310 and the barrier 384, the lens may be formed of any optically transparent material including a plastic, a polymer or glass. Further, the discussion above regarding the lens 310, the barrier 384 and the camera 340 are applicable to the lens 350, the barrier 344 and the camera 342.

There may be more than one barrier in the lens 310. For example, if the housing 382 were extended leftward and another lamp were positioned to the left, referring to FIGS. 3 and 4, of the camera 340, an additional barrier would need to be placed on the left of the camera 340 between the left side of the camera 340 and the additional lamp. In another example embodiment, if another lamp were positioned above or below the camera 340, a barrier would need to be placed above or below the camera 340 between the camera 340 and the other lamp. Depending on the location of the lamps with respect to camera 340, a respective barrier may be placed along each side (e.g., top, bottom, left, right) of the camera 340. The barrier, regardless of whether positioned with respect to the camera enables the lamps to be in close proximity with the camera without reflecting light from the outer interface 452 into the front of the camera.

### Taillight Assembly Example Embodiment

A taillight assembly is the same as the headlight assembly 300 with respect to rotational symmetry, horizontal axis, function of the barriers, placement in position of the barriers, the cameras, the field-of-views of the cameras, the sources, the reflectors, the housing, the heating element and so forth. In an example embodiment, the taillight assembly 1000 differs from the headlight assembly 300 in that that taillight assembly 1000 includes more lamps, the positions of the lamps and the sources may provide light of different colors.

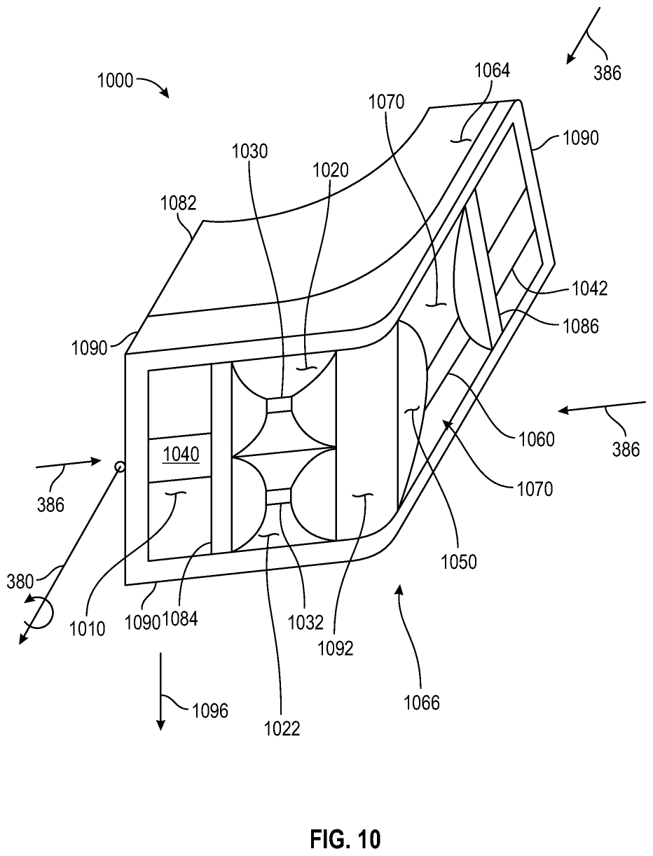

The taillight assembly 1000, as best shown in FIG. 10, includes a source 1030, a reflector 1020, a source 1060, a reflector 1070, a camera 1040, a camera 1042, at barrier 1084, a barrier 1086, a mounting frame 1090 and a housing 1082, which is all similar to the headlight assembly 300. The source 1030 and the reflector 1020 combine to form a lamp, the source 1032 and the reflector 1022 combine to form a lamp and the source 1060 and the reflector 1070 combine to form a lamp. The taillight assembly 1000 is rotationally symmetric around rotational axis 380. The divider 1092, the mounting frame 1090 and/or the reflectors 1020, 1022 and 1070 may perform the function of a heating element.

The source 1032 and reflector 1022 are placed below the source 1030 and the reflector 1020. They are positioned to be rotationally symmetric with respect to the rotational axis 380. The source 1080 produces a red light visible to humans. When the brakes are asserted, the intensity of the light provided by the source 1030 increases. The source 1032 performs the function of a backup light, so it provides white light when the vehicle is placed in reverse. The source 1060 provides an amber-colored light to serve as a turn indicator and a warning light. The taillight assembly 1000 may function as the left taillight assembly 210 or the right taillight assembly 220 without modification.

The housing 1082 includes a first side 1064 (e.g., top) and a second side 1066 (e.g., bottom). The housing 1082 of the taillight assembly 1000 encloses the source 1030, reflector 1020, the lens 1010, the source 1032, reflector 1022, the source 1060, the reflector 1070, the lens 1050, the camera 1040 and the camera 1042 between the first side 1064 and the second side 1066. The housing 382 positions the source 1030, reflector 1020, the lens 1010, the source 1032, reflector 1022, the source 1060, the reflector 1070, the lens 1050, the camera 1040 and the camera 1042 between the first side 1064, the second side 1066 and the mounting frame 1090 with respect to each other. The housing 1082 positions the vertical (e.g., up and down orientation) midpoints of the lens 1010, the source 1060, the reflector 1070, the lens 1050, the camera 1040 and the camera 1042 along the horizontal axis 386. The housing 1082 positions the bottom, referring to FIG. 10, of the reflector 1020 and the top of reflector 1022 along the horizontal axis 386.

### Headlight/Taillight System

As discussed above, the headlight assembly 300 may be placed on the left side of the front of the vehicle 100 or the right side of the front of the vehicle 100 and the taillight assembly 1000 may be placed on the left side of the rear of the vehicle 100 or the right side of the rear of the vehicle 100. However, as discussed above, rotating the headlight assembly 300 or the taillight assembly 1000 to be positioned on the right-hand or left-hand of the vehicle 100 may require that the video captured by the cameras be inverted. As a result, it is important to know which headlight assembly 300 and which taillight assembly 1000 is located on the left side or the right side of the vehicle 100 in which assembly is considered right side up.

In an example of embodiment, a headlight/taillight system 1100 knows the position of each headlight assembly 300, each taillight assembly 1000 and which assemblies are considered right side up. The headlight/taillight system 1100 includes processing circuit 1110, memory 1112, bus 1120, headlight controller 1130, headlight controller 1132, taillight controller 1140, taillight controller 1142, headlight assembly 110, headlight assembly 120, taillight assembly 210, taillight assembly 220 and user interface 1150.

### Speakers and Microphones

Although not shown in the drawing, one or more speakers and/or microphones may be included in a headlight assembly and/or a taillight assembly. The speakers and/or the microphones may be positioned with respect to the headlight assembly and the taillight assembly to be rotationally symmetrical, though neither the speakers nor the microphones need be rotationally symmetrical. The speakers and/or the microphones may be positioned at any position with respect to the cameras and/or the lamps of the headlight and/or taillight assemblies. The speakers and/or the microphones may be integrated into any portion of the headlight assembly and/or the taillight assembly including the housing (e.g., 382), the lens (e.g., 310, 350), a divider (e.g., 392), and/or a camera (e.g., 340, 342).

A portion of the speakers and/or the microphones may be exposed to the atmosphere 395 to broadcast and capture sound respectively. The portion of the speakers and/or the microphones exposed to the atmosphere 395 may have some type of protection against the elements. The speakers and/or microphones may be omnidirectional or directional. Directional speakers and/or microphones may broadcast or captured sound in an area that approximates a semi-sphere or a cone in a direction.

In an example embodiment, the speaker broadcast sound over a wide area (e.g., omnidirectional) and the microphone captures sound over a wide area. In this example embodiment, the speaker and the microphone may be positioned at any location with respect to the housing 382 and still broadcast and capture sound in front of and to the side of the vehicle 100. In an example embodiment, the speaker and the microphone are integrated into the divider 392. The speaker broadcasts sound forward and to the side of the vehicle 100. The microphone captures sound forward and to the side of the vehicle 100.

In another example embodiment, a first speaker and a first microphone are integrated into the headlight assembly 300 proximate to the camera 340. A second speaker and a second microphone are integrated into the headlight assembly 300 proximate to the camera 342. The first speaker, the second speaker, the first microphone and the second microphone are directional, so the first and second speakers broadcast sound in a direction forward of their respective cameras 340 and 342, but not so much to the sides of the cameras 340 and 342. The first and second microphones capture sound in a direction forward of their respective cameras 340 and 342, but not so much to the sides of the cameras 340 and 342. In other words, the first and second speaker broadcast in a cone-shaped area that extends forward of the respective cameras while the first and second microphones capture sound in a cone-shaped area that extends forward of their respective cameras. In this embodiment, the first speaker broadcasts and the first microphone captures sound in front of the vehicle 100 while the second speaker broadcasts and the second microphone captures sound to the side of the vehicle 100.

The same type of omnidirectional and directional speakers and microphones may be integrated into the taillight assemblies and appropriately positioned to provide and capture sound respectively.

The speakers and the microphones are configured interface with the processing circuit 1110 via the bus 1120 and/or the headlight controller 1130/1132 or the taillight controller 1140/1142. The processing circuit 1110 may control and/or configure the speakers and/or the microphones. The processing circuit 1110 may provide data to the speakers that causes the speakers to broadcast a sound. A user may provide sound for broadcast from the speakers via the user interface 1150. The processing circuit 1110 may receive data from the microphones. The data from the microphones represent captured sound. The data from the speakers may be converted to sound for the hearing by the user via the user interface 1150. The processing circuit may analyze the data from the speakers to detect the occurrence of events proximate to the vehicle 100.

### Processing Circuit

The processing circuit 1110 includes any type of controller and/or circuit for controlling and performing the functions of the headlight/taillight system 1100. For example, the processing circuit 1110 may include a microprocessor or a microcontroller, level shifters and relays. In an example embodiment, the processing circuit 1110 is a semiconductor microprocessor.

### Memory

The memory 1112 includes any type of memory that can interface with the processing circuit 1110 to store data (e.g., write) and provide data (e.g., read). In example embodiment the memory 1112 is a semiconductor memory.

### Bus

Bus 1120 is any type of bus that works with the processing circuit 1110 to send data to and receive data from the components of a headlight/taillight system 1100. In an example embodiment, the bus 1120 is a controller area network (“CAN”) bus. The bus 1120 is configured to communicate with any headlight controller, Annie headlight assembly, Annie taillight controller, Annie taillight assembly and/or the user interface 1150. The bus 1120 can transfer data between the processing circuit 1110 and any headlight controller, any headlight assembly, any taillight controller, any taillight assembly and/or the user interface 1150. The data transferred between the processing circuit 1110 and the headlight controllers, headlight assemblies, taillight controllers, taillight assemblies and/or the user interface 1150 may be any type of data and/or control signals. The processing circuit 1110 may use the bus 1120 to communicate with any headlight controller, any headlight assembly, any taillight controller, any taillight assembly and/or the user interface 1150 individually, as a group or all at the same time.

### Headlight Controller

A headlight controller is a circuit that controls the operation of a headlight assembly. For example, a headlight controller controls when source 330 operates in high beam or low beam. The headlight controller controls when the source 360 operates as a sidelight (e.g., warning light) or a turn indicator. A headlight controller may control the heating elements in the headlight assembly. The headlight controller may report data collected from sensors in the headlight assembly to the processing circuit 1110.

The processing circuit 1110 may receive data from the headlight controller. Data received from the headlight controller includes the status of the headlight assembly. Data may further include captured data from sensors inside the headlight assembly. The processing circuit 1110 may provide data to the headlight controller. Data provided to a headlight controller may include commands (e.g., instructions) that control the operation of the headlight controller and in turn control the operation of the headlight assembly. For example, the headlight controller may report the temperature of the headlight assembly. The processing circuit may instruct the headlight controller to turn on the heating element in the headlight assembly responsive to the temperature. The processing circuit 1110 may send commands to the headlight controller to control the operation of the sources (e.g., on, off, intensity, color, blinking).

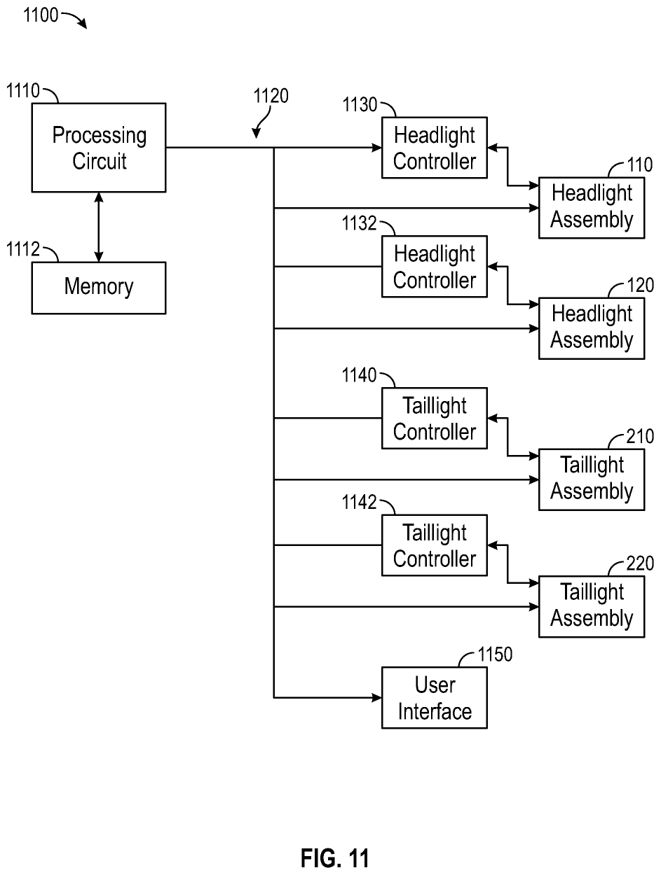

In an example embodiment, best shown in FIG. 11, the headlight controller 1130 interfaces with and controls the headlight assembly 110. The headlight controller 1132 interfaces with and controls the headlight assembly 120.

The processing circuit 1110 may also communicate directly with a headlight assembly. In an example embodiment, the headlight assembly sends data captured by the cameras 340 and 342 directly to the processing circuit 1110 via a bus 1120. In an example embodiment, the processing circuit 1110 controls the operation (e.g., frame rate, light level, data format) of the cameras 340 and 342 via communication directly with the headlight assembly. In another example embodiment, the processing circuit 1110 controls the operation of the cameras 340 and 342 via the headlight controller 1130.

### Taillight Controller

A taillight controller is a circuit that controls the operation of a taillight assembly. For example, a taillight controller controls when source 1030 operates as a taillight or a brake light. The taillight controller controls when the source 1060 operates as a sidelight (e.g., warning light) or a turn indicator. The taillight controller controls when the source 1032 is on or off. A taillight controller may control the heating elements in the taillight assembly. The taillight controller may report data collected from sensors in the taillight assembly to the processing circuit 1110.

For example, the processing circuit 1110 receives data from the taillight controller. Data received from the taillight controller includes the status of the taillight assembly, captured data from sensors inside the taillight assembly. The processing circuit 1110 may provide data to the taillight controller. Data provided to a taillight controller may include commands (e.g., instructions) that control the operation of the taillight controller and in turn the operation of the taillight assembly. For example, the taillight controller may report the temperature of the taillight assembly. The processing circuit may instruct the taillight controller to turn on the heating element in the taillight assembly responsive to the temperature. The processing circuit 1110 may send commands to the taillight controller to control the operation of the sources 1030, 1060 and 1032.

In an example embodiment, best shown in FIG. 11, the taillight controller 1140 interfaces with and controls the taillight assembly 210. The taillight controller 1142 interfaces with and controls the taillight assembly 220.

The processing circuit 1110 may also communicate directly with a taillight assembly. In an example embodiment, the taillight assembly sends data captured by the cameras 1040 and 1042 directly to the processing circuit 1110 via a bus 1120. In an example embodiment, the processing circuit 1110 controls the operation (e.g., frame rate, light level, data format) of the cameras 1040 and 1042 directly. In another example embodiment, the processing circuit 1110 controls the operation of the cameras 1040 and 1042 via the taillight controller 1140.

### User Interface

A user interface enables a user to provide data to and receive data from the headlight/taillight system 1100. In an example embodiment, the user interface 1150 is a touch screen device in addition to other controls of the vehicle 100, such as the brake pedal, the turn signal control, the high beam switch and the transmission control. A user may provide information to the processing circuit 1110 via the user interface 1150. The other controls of the vehicle 100 may provide information to control the high beams and low beams of the headlight assemblies 110 and 120, to control source 1030 to operate as a taillight or a brake light, to turn source 1032 on when backing up off otherwise and to control source 360 and/or 1060 to operate (e.g., flash) as a turn signal. Information provided by the processing circuit 1110 to the user via the user interface 1150 may include video data captured by one or more of the cameras of the headlight assemblies 110 and 120 and/or the taillight assemblies 210 and 220.

### Identifying Headlight/Taillight Assembly Position

Because the processing circuit 1110 control signals to the headlight assembly 300 and the taillight assemblies 1000, the processing circuit needs to know where the headlight assemblies 300 are positioned (e.g., 110, 120) and where the taillight assemblies 1000 are positioned (e.g., 210, 220), so the correct control signals are sent to the proper headlight assembly 300 or taillight assembly 1000. Further, knowing the position of the headlight assemblies 300 and the taillight assemblies 1000 enables the processing circuit 1110 to understand the video data received from the cameras, particularly the orientation (e.g., forward, rearward, right-front side, left-front side, right-veers side, left-rear side) of the field-of-view of the cameras.

In an example embodiment, after installation of the headlight assemblies 110 or 120 and/or the taillight assemblies 210 or 220, each camera of the headlight assemblies 110 and 120 and the taillight assemblies 210 and 220 present video to the user on the user interface 1150. The user, via the user interface 1150, identifies the cameras that pertain to headlight assemblies 110 and 120, and the taillight assemblies 210 and 220, the position of the camera on the assembly (e.g., forward, reverse, side), and whether the processing circuit 1110 should invert (e.g., flip top for bottom) the video from the camera to properly represent up and down with respect to the environment. Once the user has identified the position of each headlight and taillight assembly on the vehicle 100, the processing circuit 1110 can determine how to properly control the sources and the cameras. Further, the processing circuit 1110 stores information in the memory 1112. The user need provide this information only once, because even if a headlight or taillight is replaced, its position with respect to the vehicle 100 is the same as the previous headlight or taillight.

In another example embodiment, each location where a headlight assembly or taillight assembly is positioned is assigned an address. Each time the processing circuit 1110 reads from or writes to a specific address, a specific position on the vehicle 100 is addressed. For example, assume that the front right side, the front left side, the rear right side and the rear left side are assigned the address ranges 1XX, 2XX, 3XX and 4XX respectively. Each time the processing circuit 1110 reads or writes to the address range 1XX, the processing circuit 1110 communicates with the headlight controller 1132 and/or headlight assembly 120. Each time the processing circuit 1110 reads or writes to the address range 2XX, the processing circuit 1110 communicates with the headlight controller 1130 and/or headlight assembly 110. Each time the processing circuit 1110 reads or writes to the address range 3XX, the processing circuit 1110 communicates with the taillight controller 1142 and/or taillight assembly 220. Each time the processing circuit 1110 reads or writes to the address range 4XX, the processing circuit 1110 communicates with the taillight controller 1140 and/or taillight assembly 210.

In another example embodiment, each headlight assembly 300 and each taillight assembly 1000 is assigned a different address a respective of where the headlight assembly 300 or the taillight assembly 1000 is later positioned on the vehicle 100. When the processing circuit 1110 issues a specific address on the bus 1120, it communicates with headlight assembly or a taillight assembly and/or its associated controller assigned that address. During manufacture, the technician must inform the processing circuit 1110 of the location of each address relative to the vehicle 100. Such information may be provided to the processing circuit 1110 via the user interface 1150 or any other means. In another example of manufacture, the headlight assembly and corresponding headlight controller with a first address are always installed as the left headlight assembly 110 and associated headlight controller, the headlight assembly and corresponding headlight controller with a second address are always installed as the right headlight assembly 120 and corresponding headlight controller, the taillight assembly and corresponding taillight controller with a third address are always installed as the left taillight assembly 210 and the taillight assembly and corresponding taillight controller with a fourth address are always installed as the right taillight assembly 220.

In another example embodiment, the headlight assembly 300 includes a detector (e.g., mercury switch, gyroscope) that detects the orientation (e.g., up, down) of the headlight assembly 300. For example, the detector detects whether the first side 364 or the second side 366 of the headlight assembly 300 is oriented upward with respect to gravity or downward. The taillight assembly 1000 may also include such a detector to determine whether the first side 1064 or the second side 1066 is oriented upward or downward.

As discussed above, the headlight assembly 110 is rotated 180° with respect to the headlight assembly 120. So, if the first side 364 of the headlight assembly 110 is oriented upward and the second side oriented downward, then the second side 366 of the headlight assembly 120 is oriented upward, while the first side 364 is oriented downward. The same applies to the orientation of the first side 1064 and the second side 1066 of the taillight assemblies 210 and 220. Because of the position of the source 330 (e.g., forward) with respect to the source 360 (e.g., to the side), the first side 364 will always be positioned upward when positioned on the front left of the vehicle 100 (e.g., headlight assembly 110) and downward when positioned on the front right of the vehicle 100 (e.g., headlight assembly 120). The processing circuit 1110 may query each headlight assembly (e.g., 110, 120) regarding the orientation of its respective first side 1064. The processing circuit 1110 may use the information returned from the headlight assemblies 300 to determine whether the headlight assembly 300 is positioned at the front left or the front right of the vehicle. The same may be done with respect to the orientation of the first side 1064 to determine the position (e.g., right rear, left rear) of the taillight assemblies 1000 (e.g., 210, 220) with respect to the vehicle 100.

In another example embodiment, a first set of lines (e.g., conductors) of the bus 1120 communicate with the headlight controller 1130 and the headlight assembly 110, a second set of lines communicate with the headlight controller 1132 and the headlight assembly 120, a third set of lines communicate with the taillight controller 1140 and the taillight assembly 210, and a fourth set of lines communicate with the taillight controller 1142 and the taillight assembly 220. Each set of lines is mutually exclusive of all the other set of lines. During assembly of the vehicle, the first set of lines extend from the position of the processing circuit 1011 to front left of the vehicle, the second set of lines extend to the front right of the vehicle, the third set of lines extend to the left rear of the vehicle, and the fourth set of lines extend to the right rear of the vehicle. Connecting the various headlight assemblies 300 and taillight assemblies 1000 to the respective set of lines inherently identifies the position of the headlight assembly 300 and the taillight assemblies 1000 and their associated controllers.

### Afterword

The foregoing description discusses implementations (e.g., embodiments), which may be changed or modified without departing from the scope of the present disclosure as defined in the claims. Examples listed in parentheses may be used in the alternative or in any practical combination. As used in the specification and claims, the words ‘comprising’, ‘comprises’, ‘including’, ‘includes’, ‘having’, and ‘has’ introduce an open-ended statement of component structures and/or functions. In the specification and claims, the words ‘a’ and ‘an’ are used as indefinite articles meaning ‘one or more’. While for the sake of clarity of description, several specific embodiments have been described, the scope of the invention is intended to be measured by the claims as set forth below. In the claims, the term “provided” is used to definitively identify an object that is not a claimed element but an object that performs the function of a workpiece. For example, in the claim “an apparatus for aiming a provided barrel, the apparatus comprising: a housing, the barrel positioned in the housing”, the barrel is not a claimed element of the apparatus, but an object that cooperates with the “housing” of the “apparatus” by being positioned in the “housing”.

The location indicators “herein”, “hereunder”, “above”, “below”, or other word that refer to a location, whether specific or general, in the specification shall be construed to refer to any location in the specification whether the location is before or after the location indicator.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods.

What is claimed is:

1. A headlight assembly comprising:
a housing;
a lens having an inner surface, an outer surface, a first portion, a second portion and an outer interface between the outer surface and an atmosphere;
a barrier positioned between the first portion and the second portion of the lens;
a reflector having a first front portion and a first side;
a source positioned in the reflector, the source configured to provide a plurality of beams of light; and
a camera having a second front portion and a second side, the camera configured to capture images via the second front portion of the camera; wherein:
the source, the reflector and the camera are positioned in the housing;
the source, the reflector and the camera are positioned rotationally symmetrical to a horizontal axis;
the first front portion of the reflector is positioned proximate to or against the inner surface of the first portion of the lens;
the first side of the reflector is positioned proximate to the barrier;
the second front portion of the camera positioned proximate to or against the inner surface of the second portion of the lens;
the second side of the camera positioned proximate to the barrier opposite the reflector;
one or more beams of light of the plurality of beams of light reflect from the outer interface in a direction toward the camera, the one or more beams that reflect referred to as one or more reflected beams; and
the barrier is configured to absorb or reflected the one or more reflected beams to stop the one or more reflected beams from entering the second front portion of the camera thereby reducing interference of the one or more reflected beams with image capture by the camera.

2. The headlight assembly of claim 1 wherein a first height of the barrier is equal to a second height of the lens.

3. The headlight assembly of claim 1 wherein the first side of the reflector is separated from the second side of the camera by a width of the barrier.

4. The headlight assembly of claim 1 wherein:
the barrier has a third side and a fourth side;
the first side of the reflector is positioned proximate to the third side of the barrier; and
the second side of the camera is positioned proximate to the fourth side of the barrier whereby the reflector is positioned a width of the barrier away from the camera.

5. The headlight assembly of claim 1 wherein the inner surface of the lens is coated with an anti-reflective coating.

6. The headlight assembly of claim 1 wherein the reflector is formed of a heating element whereby the reflector heats the lens.

7. A headlight assembly comprising:
a housing;
a lens having a first portion, a second portion, an outer surface and an outer interface between the outer surface and an atmosphere;
a barrier positioned between the first portion and the second portion of the lens;
a reflector having a first front portion;
a source positioned in the reflector, the source configured to provide a plurality of beams of light, the reflector configured to reflect a portion of the plurality of beams of light out the first front portion of the reflector; and
a camera having a second front portion, the camera configured to capture images via the second front portion of the camera; wherein:
the source, the reflector and the camera are positioned in the housing;
the reflector is positioned proximate to the barrier and the first portion;
the camera is positioned proximate to the barrier and the second portion;
one or more beams of light of the plurality of beams of light reflect from the outer interface in a direction toward the second front portion of the camera, the one or more beams that reflect referred to as one or more reflected beams; and
the barrier is configured to absorb or reflected the one or more reflected beams to stop the one or more reflected beams from entering the second front portion of the camera thereby reducing interference of the one or more reflected beams with image capture by the camera.

8. The headlight assembly of claim 7 wherein the camera is positioned opposite the camera across a width of the barrier.

9. The headlight assembly of claim 7 wherein a first height of the barrier is equal to a second height of the lens.

10. The headlight assembly of claim 7 wherein a first thickness of the barrier is equal to a second thickness of the lens.

11. The headlight assembly of claim 7 wherein:
the barrier is formed by polishing at least one of a first end portion of the first portion of the lens and a second end portion of the second portion of the lens; and
the first end portion is positioned proximate to the second portion.

12. The headlight assembly of claim 7 wherein the barrier is bonded between a first end portion of the first portion of the lens and a second end portion of the second portion of the lens during manufacture.

13. The headlight assembly of claim 7 wherein the barrier does not obstruct the first front portion of the reflector or the second front portion of the camera.

14. The headlight assembly of claim 7 wherein the source, the reflector and the camera are positioned rotationally symmetrical to a horizontal axis.

15. The headlight assembly of claim 7 wherein the reflector is formed of a heating element whereby the reflector heats the lens.

16. A headlight assembly comprising:
a housing having a forward portion and a side portion; the forward portion oriented orthogonally to the side portion;
a first source and a second source;
a first reflector and a second reflector, the first source positioned in the first reflector and the second source positioned in the second reflector respectively, the first source configured to provide a first plurality of beams of light, the second source configured to provide a second plurality of beams of light, the first reflector configured to reflect a portion of the first plurality of beams of light out a first front portion of the first reflector, the second reflector configured to reflect a portion of the second plurality of beams of light out a second front portion of the second reflector, the first reflector oriented orthogonally to the second reflector, the first reflector and the first source positioned in the forward portion of the housing, the second reflector and the second source positioned in the side portion of the housing;
a first lens and a second lens, the first lens having a first portion and a second portion, the first portion having a first inner surface and the second portion having a second inner surface, the second lens having a third portion and a fourth portion, the third portion having a third inner surface and the fourth portion having a fourth inner surface;
a first barrier and a second barrier, the first barrier positioned between the first portion of the second portion of the first lens, the second barrier positioned between the third portion and the fourth portion of the second lens, the first lens and the first barrier positioned in the forward portion of the housing, the second lens and the second barrier positioned in the side portion of the housing; and
a first camera having a first opening and a second camera having a second opening, the first camera configured to capture images via the first opening, the second camera configured to capture images via the second opening, the first opening of the first camera positioned proximate to or touching the second inner surface of the second portion of the first lens, the first reflector positioned proximate to or touching the first inner surface of the first portion of the first lens, the first reflector positioned opposite the first camera across the first barrier, the second opening of the second camera positioned proximate to or touching the fourth inner surface of the fourth portion of the second lens, the second reflector positioned proximate to or touching the third inner surface of the third portion of the second lens, the second reflector positioned opposite the second camera across the second barrier; wherein:
the first barrier is configured to absorb or reflected all beams of light of the first plurality of beams of light that travel in a first direction toward the first opening of the first camera thereby reducing interference with image capture by the first camera; and
the second barrier is configured to absorb or reflected all beams of light of the second plurality of beams of light that travel in a second direction toward the second opening of the second camera thereby reducing interference with image capture by the second camera.

17. The headlight assembly of claim 16 wherein the first source, the first reflector, the first camera, the second source, the second reflector and the second camera are positioned rotationally symmetrical to a horizontal axis.

18. The headlight assembly of claim 16 wherein at least one of the first reflector and the second reflector are formed of a heating element respectively whereby the first reflector and the second reflector heat the first lens and the second lens respectively.

19. The headlight assembly of claim 16 further comprising a mounting frame wherein the mounting frame heats at least one of the first lens and the second lens.
